(19) United States
(12) Patent Application Publication
(10) Pub. No.: US 2021/0158610 A1
(43) Pub. Date: May 27, 2021

(54) METHOD AND DEVICE FOR GENERATING TERRAIN DATA FOR TERRAIN ANALYSIS

(71) Applicant: Electronics and Telecommunications Research Institute, Daejeon (KR)

(72) Inventors: Sung Woong CHOI, Daejeon (KR); Ho Kyung SON, Daejeon (KR); Young Jun CHONG, Daejeon (KR); Heon Jin HONG, Daejeon (KR)

(73) Assignee: Electronics and Telecommunications Research Institute, Daejeon (KR)

(21) Appl. No.: 16/737,593

(22) Filed: Jan. 8, 2020

(30) Foreign Application Priority Data
Nov. 21, 2019 (KR) 10-2019-0150350

(51) Int. Cl. G06T 17/05; G06T 7/50; G09B 25/06

(52) U.S. Cl. CPC G06T 17/05; G06T 2207/30181; G09B 25/06; G06T 7/50

(57) ABSTRACT

Disclosed is a method and device for generating terrain data for terrain analysis. The method may include identifying first data including (i) identification information indicating whether there is a structure in a predetermined area and the number of structures and (ii) a topographic altitude of the predetermined area, identifying, if there is a structure in the predetermined area, second data including a highest altitude of the structure and a depth of the structure, and mapping the first data and the second data to terrain data of the predetermined area.

### CROSS-REFERENCE TO RELATED APPLICATION(S)

This application claims the benefit of Korean Patent Application No. 10-2019-0150350, filed on Nov. 21, 2019, in the Korean Intellectual Property Office, the disclosure of which is incorporated herein by reference.

### BACKGROUND

### 1. Field of the Invention

One or more example embodiments relate to a method and device for generating terrain data for terrain analysis and, more particularly, to a method and device for generating terrain data by mapping data including information related to a structure to the terrain data.

### 2. Description of the Related Art

The existing technology for terrain analysis performs an analysis based on a digital elevation model that represents the bare earth portion, except for buildings, trees, and artificial structures in the actual terrain, in the form of two-dimensional (2d) grids at predetermined intervals.

Here, the digital elevation model may indicate terrain data. In this example, the analysis may be performed by utilizing three-dimensional (3D) vectors or volume pixels (voxels) to reflect information associated with a structure such as a building on the actual terrain. However, the above scheme requires a large quantity of data and decreases the operation processing rate.

### SUMMARY

An aspect provides a method and device that may accurately and efficiently analyze terrain by generating terrain data reflecting information associated with a structure such as a building on the actual terrain.

Another aspect also provides a method and device that may be applied without changing all existing terrain data, thereby solving the issues described above without replacement with new equipment or data.

According to an aspect, there is provided a method of generating terrain data, the method including identifying first data including (i) identification information indicating whether there is a structure in a predetermined area and the number of structures and (ii) a topographic altitude of the predetermined area, identifying, if there is a structure in the predetermined area, second data including a highest altitude of the structure and a depth of the structure, and mapping the first data and the second data to terrain data of the predetermined area.

The mapping may include mapping the first data and the second data related to the predetermined area to one of a plurality of grids representing the terrain data, wherein the one grid may correspond to the predetermined area.

The plurality of grids may be grouped into a plurality of tiles of the same size, and an index may be set for a tile in which a structure is present, among the plurality of tiles.

According to another aspect, there is provided a method of generating terrain data, the method including identifying first data including (i) a topographic altitude of a predetermined area, (ii) a highest altitude of a structure in the predetermined area, and (iii) a depth of the structure, identifying, if there are a plurality of structures in the predetermined area, second data including respective highest altitudes and depths of the structures, and mapping the first data and the second data to terrain data of the predetermined area.

The mapping may include mapping the first data and the second data related to the predetermined area to one of a plurality of grids representing the terrain data, wherein the one grid may correspond to the predetermined area.

The plurality of grids may be grouped into a plurality of tiles of the same size, and an index may be set for a tile in which a structure is present, among the plurality of tiles.

According to another aspect, there is provided a device for generating terrain data, the device including a processor configured to identify first data including (i) identification information indicating whether there is a structure in a predetermined area and the number of structures and (ii) a topographic altitude of the predetermined area, identify, if there is a structure in the predetermined area, second data including a highest altitude of the structure and a depth of the structure, and map the first data and the second data to terrain data of the predetermined area.

The processor may be configured to map the first data and the second data related to the predetermined area to one of a plurality of grids representing the terrain data, wherein the one grid may correspond to the predetermined area.

The plurality of grids may be grouped into a plurality of tiles of the same size, and an index may be set for a tile in which a structure is present, among the plurality of tiles.

According to another aspect, there is provided a device for generating terrain data, the device including a processor configured to identify first data including (i) a topographic altitude of a predetermined area, (ii) a highest altitude of a structure in the predetermined area, and (iii) a depth of the structure, identifying, if there are a plurality of structures in the predetermined area, second data including respective highest altitudes and depths of the structures, and mapping the first data and the second data to terrain data of the predetermined area.

The processor may be configured to map the first data and the second data related to the predetermined area to one of a plurality of grids representing the terrain data, wherein the one grid may correspond to the predetermined area.

The plurality of grids may be grouped into a plurality of tiles of the same size, and an index may be set for a tile in which a structure is present, among the plurality of tiles.

According to another aspect, there is provided a non-transitory computer-readable recording medium that may record terrain data of a predetermined area to which first data and second data are mapped, wherein the first data includes (i) identification information indicating whether there is a structure in the predetermined area and the number of structures and (ii) a topographic altitude of the predetermined area, and the second data includes, if there is a structure in the predetermined area, a highest altitude and a depth of the structure.

According to another aspect, there is provided a non-transitory computer-readable recording medium that may record terrain data of a predetermined area to which first data and second data are mapped, wherein the first data includes (i) a topographic altitude of the predetermined area, (ii) a highest altitude of a structure in the predetermined area, and (iii) a depth of the structure, and the second data includes, if there are a plurality of structures in the predetermined area, respective highest altitudes and depths of the structures.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a terrain data generating device according to an example embodiment;

FIG. 2 illustrates a cross-section of terrain according to an example embodiment;

FIG. 3 is a flowchart illustrating a terrain data generating method according to an example embodiment;

FIG. 4 is a flowchart illustrating a terrain data generating method according to an example embodiment;

FIG. 5 illustrates structures of data mapped to terrain data according to an example embodiment; and

FIG. 6 illustrates a process of tiling terrain data and mapping according to an example embodiment.

### DETAILED DESCRIPTION

Hereinafter, some example embodiments will be described in detail with reference to the accompanying drawings. However, various alterations and modifications may be made to the example embodiments. Here, the example embodiments are not construed as limited to the disclosure and should be understood to include all changes, equivalents, and replacements within the idea and the technical scope of the disclosure.

The terminology used herein is for the purpose of describing particular example embodiments only and is not to be limiting of the example embodiments. As used herein, the singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the example embodiments with reference to the accompanying drawings, like reference numerals refer to like constituent elements and a repeated description related thereto will be omitted. In the description of example embodiments, detailed description of well-known related structures or functions will be omitted when it is deemed that such description will cause ambiguous interpretation of the present disclosure.

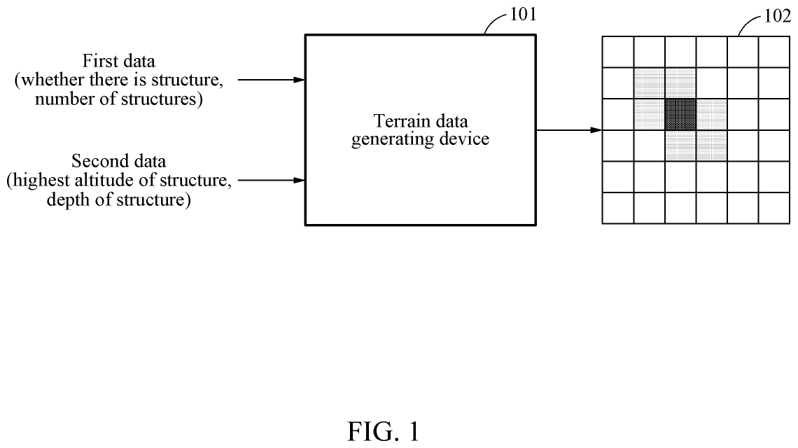

FIG. 1 is a diagram illustrating a terrain data generating device according to an example embodiment.

Referring to FIG. 1, a terrain data generating device 101 may include a processor configured to perform a terrain data generating method according to an example embodiment. The terrain data generating device 101 may identify first data including identification information indicating whether there is a structure in a predetermined area and the number of structures and a topographic altitude of the predetermined area.

In general, terrain data represent the bare earth portion, except for buildings, trees, and artificial structures in the actual terrain, in the form of two-dimensional (2D) grids at predetermined intervals. However, terrain data 102 generated according to the example embodiment may be represented in the form of 2D grids and include information related to buildings, trees, and artificial structures.

In this example, the predetermined area may refer to an area corresponding to a predetermined longitude and a predetermined latitude in the terrain. Further, the predetermined area may refer to an area at a horizontal distance X and at a vertical distance Y from a predetermined reference point in the terrain. Thus, the predetermined area may correspond to one of 2D grids constituting the terrain data.

The structure may refer to a building, a tree, or an artificial structure installed on the ground. Further, the topographic altitude may refer to an elevation of the predetermined area from the sea level.

The terrain data generating device 101 may determine whether there is at least one structure in the predetermined area through the identification information. If there is no structure in the predetermined area, the terrain data generating device 101 may map the identified first data to the terrain data.

Conversely, if there is at least one structure in the predetermined area, the terrain data generating device 101 may identify second data including a highest altitude and a depth of the structure. The terrain data generating device 101 may generate the terrain data 102 by mapping the first data and the second data to the terrain data.

The highest altitude of the structure may refer to a distance from the sea level to the top of the structure. Further, the depth of the structure may refer to a distance from the highest altitude of the structure to the bottom of the structure.

Herein, the number of structures in the predetermined area may refer to the number of structures if a number of structures are present together in the predetermined area, and a sum of the number of structures and the number of protruding portions if a protruding portion of a structure installed in another area is present in the predetermined area.

In another example, irrespective of whether there is a structure in the predetermined area, the terrain data generating device 101 may identify first data including a topographic altitude of the predetermined area, a highest altitude of a structure present in the predetermined area, and a depth of the structure.

If there is one or no structure in the predetermined area, the terrain data generating device 101 may map the first data to the terrain data of the predetermined area. In this example, if there is no structure, the highest altitude of the structure and the depth of the structure in the first data may be “0”.

Conversely, if there are a plurality of structures in the predetermined area, the terrain data generating device 101 may identify second data including respective highest altitudes and depths of the structures. The terrain data generating device 101 may generate the terrain data 102 by mapping the first data and the second data to the terrain data of the predetermined area.

In an example, a recording medium may record terrain data of a predetermined area to which first data and second data are mapped, wherein the first data includes (i) identification information indicating whether there is a structure in the predetermined area and the number of structures and (ii) a topographic altitude of the predetermined area, and the second data includes, if there is a structure in the predetermined area, a highest altitude and a depth of the structure.

In another example, a recording medium may record terrain data of a predetermined area to which first data and second data are mapped, wherein the first data includes (i) a topographic altitude of the predetermined area, (ii) a highest altitude of a structure in the predetermined area, and (iii) a depth of the structure, and the second data includes, if there are a plurality of structures in the predetermined area, respective highest altitudes and depths of the structures.

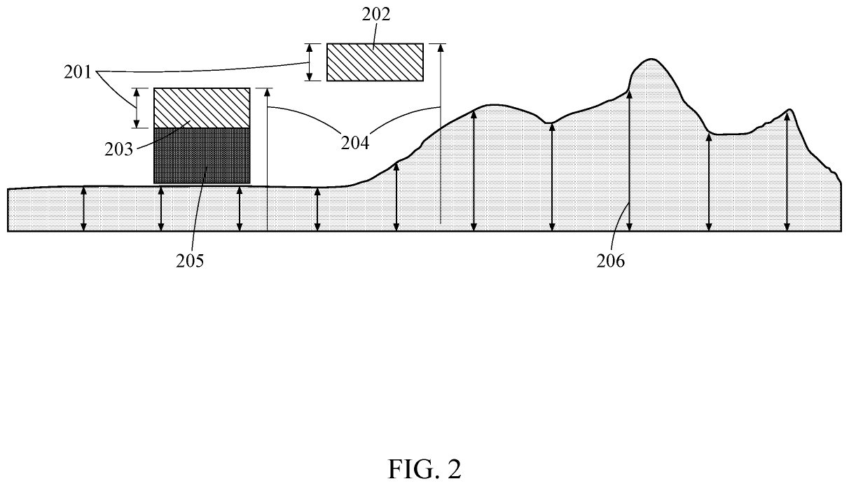

FIG. 2 illustrates a cross-section of terrain according to an example embodiment.

Referring to FIG. 2, a structure, such as a bridge, with a portion spaced apart from the ground may be represented like a structure 203 with a portion not contacting the ground surface, in a cross-section of terrain. Further, there may be a structure 203, 205 with a portion protruding outward, among structures such as buildings, trees, and artificial structures.

The structure 203, 205 may be in contact with the ground surface, and the protruding portion 203 of the structure may be spaced apart from the ground surface in the cross-section. That is, herein, a structure in a predetermined area may be a structure spaced apart from the ground surface, like the structure 202, 203 of FIG. 2. Further, the structure 202 may be a structure floating in the air.

In this example, a highest altitude 204 in second data may be a distance from the sea level to the top of the structure 202, 203. A depth 201 in the second data may be a distance from the highest altitude to the bottom of the structure 202, 203 close to the ground surface.

In this example, the structure 205 in contact with the ground surface is not in contact with the ground surface in an area of FIG. 2, and thus may not be included in the second data. A topographic altitude 206 in first data may refer to an altitude of terrain corresponding to each area. The topographic altitude 206 may be an altitude of predetermined terrain.

Further, there may be a number of protruding portions of structures in a predetermined area. In this example, respective highest altitudes and depths of the protruding portions may be included in the second data. In this example, a highest altitude may be a distance from the sea level to a highest point of a protruding portion. Further, a depth may be a distance from the highest altitude of the protruding portion to a point close to the ground surface.

That is, if a structure is spaced apart from the ground surface corresponding to the predetermined area, the depth may be a distance from the bottom of the structure to the highest altitude of the structure on the ground surface corresponding to the predetermined area.

Conversely, if a structure is in contact with the ground surface corresponding to the predetermined area, the depth may be a distance from the ground surface corresponding to the predetermined area to the highest altitude of the structure.

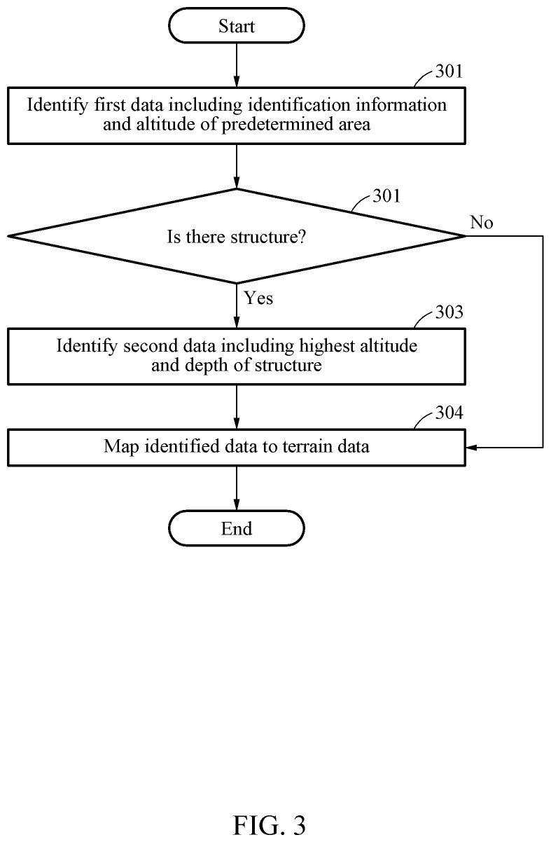

FIG. 3 is a flowchart illustrating a terrain data generating method according to an example embodiment.

In operation 301, the terrain data generating device 101 may identify first data including (i) identification information indicating whether there is a structure in a predetermined area and the number of structures and (ii) a topographic altitude of the predetermined area.

In operation 302, the terrain data generating device 101 may determine whether there is a structure based on the identification information. If there is a structure in the predetermined area, the terrain data generating device 101 may perform operation 303 and operation 304. However, if there is no structure in the predetermined area, the terrain data generating device 101 may perform operation 304.

In operation 303, the terrain data generating device 101 may identify, if there is a structure in the predetermined area, second data including a highest altitude of the structure and a depth of the structure. If there are two or more structures in the predetermined area, the second data may include respective highest altitudes and depths of the structures.

In operation 304, the terrain data generating device 101 may map the identified data to terrain data. If there is no structure in the predetermined area, only the first data may be mapped to the terrain data. If there is at least one structure in the predetermined area, the first data and second data corresponding to the number of structures may be mapped to the terrain data.

In an example, the terrain data generating device 101 may map the first data and the second data to the predetermined area corresponding to one of a plurality of grids representing the terrain data. The plurality of grids may be grouped into a plurality of tiles of the same size. In this example, a tile may include a plurality of grids. The terrain data generating device 101 may set an index for a tile in which a structure is present, among the plurality of tiles.

In another example, the terrain data generating device 101 may map the first data to the predetermined area corresponding to one of a plurality of grids representing the terrain data. The plurality of grids may be grouped into a plurality of tiles of the same size.

In this example, the terrain data generating device 101 may determine the tile in which a structure is present, among the plurality of tiles, based on the identification information of the first data. The terrain data generating device 101 may set an index for the tile in which a structure is present.

The terrain data generating device 101 may map second data corresponding to the index for the tile in which a structure is present. If the data are mapped as described above, a processor of the terrain data generating device 101 may access the second data with the index, thereby efficiently identifying the second data.

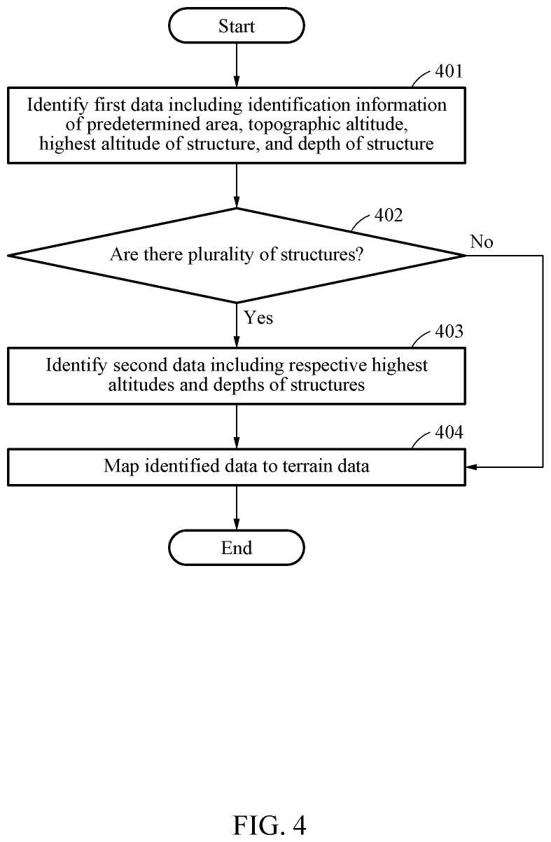

FIG. 4 is a flowchart illustrating a terrain data generating method according to an example embodiment.

In operation 401, the terrain data generating device 101 may identify first data including (i) a topographic altitude of a predetermined area, (ii) a highest altitude of a structure in the predetermined area, and (iii) a depth of the structure, irrespective of whether there is a structure in a predetermined area.

In operation 402, the terrain data generating device 101 may determine whether there are a plurality of structures in the predetermined area. If there are a plurality of structures in the predetermined area, the terrain data generating device 101 may perform operation 403 and operation 404. However, if there is no structure in the predetermined area, the terrain data generating device 101 may perform operation 404.

In operation 403, the terrain data generating device 101 may identify, if there are a plurality of structures in the predetermined area, second data including respective highest altitudes and depths of the structures. In this example, the highest altitude and the depth of the structure included in the first data may be excluded.

In operation 404, the terrain data generating device 101 may map the identified data to terrain data. If there is one structure in the predetermined area, only the first data may be mapped to the terrain data. If there is at least one structure in the predetermined area, the first data and the second data corresponding to the number of structures may be mapped to the terrain data.

In an example, the terrain data generating device 101 may map the first data and the second data to the predetermined area corresponding to one of a plurality of grids representing the terrain data. The plurality of grids may be grouped into a plurality of tiles of the same size. In this example, a tile may include a plurality of grids.

The terrain data generating device 101 may set an index for a tile in which a structure is present, among the plurality of tiles. The terrain data generating device 101 may map the second data based on the set index.

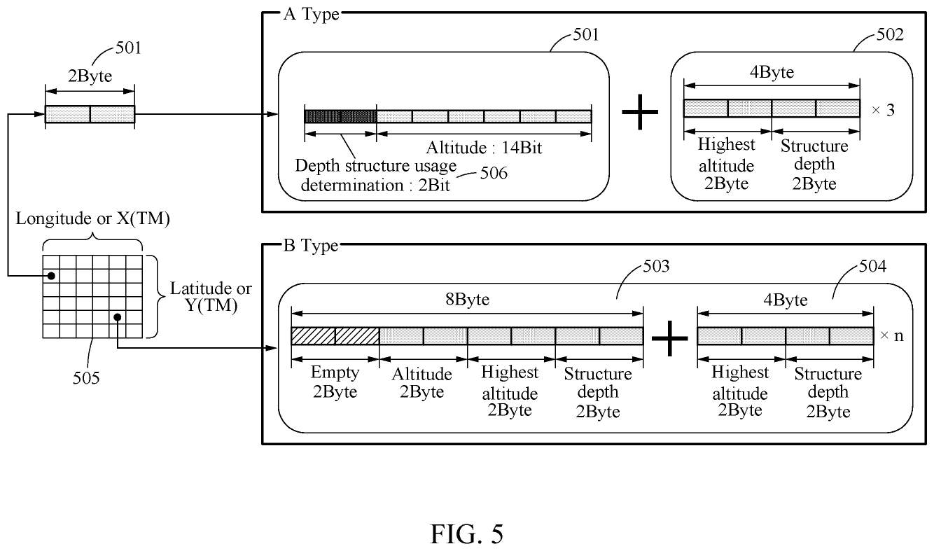

FIG. 5 illustrates structures of data mapped to terrain data according to an example embodiment.

In FIG. 5, A Type shows an example of first data 501 and second data 502. The first data may include identification information 506 indicating whether there is a structure in a predetermined area and the number of structures and a topographic altitude of the predetermined area.

For example, as shown in FIG. 5, the first data may be 2 bytes and include the identification information 506 in 2 bits and the topographic altitude of the predetermined area in the remaining 14 bits. If converting 2 bits to decimal, 2 bits may be an integer in the range of “0” to “3”. Further, if converting 14 bits to decimal, 14 bits may be an integer in the range of “0” to “16,383”. That is, altitude data may include an altitude value in the range of up to 16,383 meters.

In the example of FIG. 5, the terrain data generating device 101 may map the second data 502 based on the identification information 506. For example, the second data 502 may be 4 bytes and include a highest altitude of a structure in 2 bytes and a depth of the structure in the remaining 2 bytes. A Type of FIG. 5 shows an example of mapping a total of three items of second data to the terrain data, when the identification information 506 indicates that there are three structures in the area and three values are converted to decimal.

In FIG. 5, 2D grids may indicate terrain data 505. In this example, a predetermined area may correspond to one of the plurality of grids constituting the terrain data. In an example, the predetermined area may correspond to a predetermined longitude and a predetermined latitude on the terrain data 505. In another example, the predetermined area may be an area at a horizontal distance X and at a vertical distance Y from a predetermined reference point on the terrain data 505.

In FIG. 5, B Type shows another example of first data 503 and second data 504. The first data 503 may include (i) a topographic altitude of a predetermined area, (ii) a highest altitude of a structure in the predetermined area, and (iii) a depth of the structure, irrespective of whether there is a structure in the predetermined area.

For example, as shown in FIG. 5, the first data 503 may be 8 bytes and include the topographic altitude of the predetermined area in 2 bytes, the highest altitude of the structure in 2 bytes, and the depth of the structure in the remaining 2 bytes.

If there is a plurality of structures, for example, n structures, in the predetermined area, second data may include respective highest altitude and depths of the plurality of structures, for example, the n structures. In this example, the second data 504 may be 4 bytes and include the highest altitudes of the structures in 2 bytes and the depths of the structures in the remaining 2 bytes. In this example, n may be the number of structures in the predetermined area, and may be, if there is a protruding portion of a structure installed in another area is present in the predetermined area, a sum of the number of structures and the number of protruding portions.

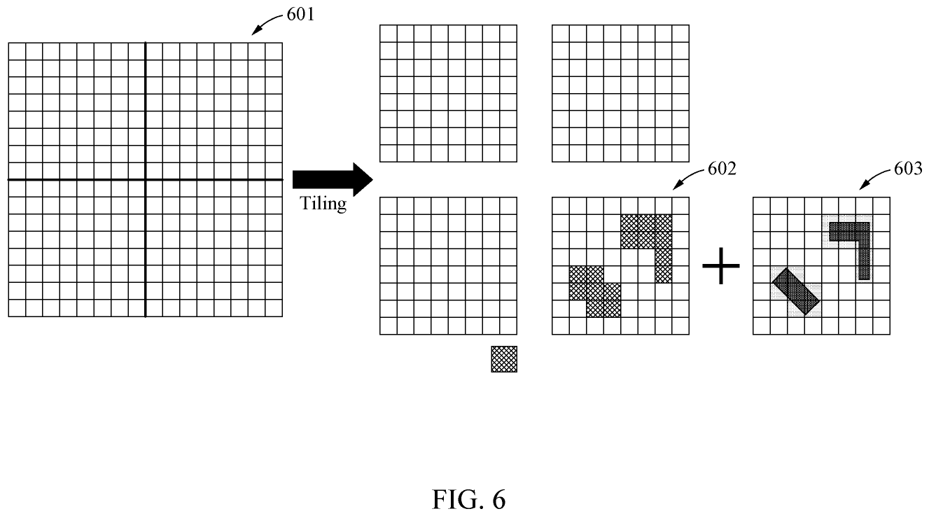

FIG. 6 illustrates a process of tiling terrain data and mapping according to an example embodiment.

Referring to FIG. 6, terrain data 601 may be represented by 2D grids. The grids constituting the terrain data 601 may each be a predetermined area. A terrain data generating system may group the plurality of grids into a plurality of tiles of the same size as shown in FIG. 6. In this example, a tile may include a plurality of grids.

The terrain data generating device 101 may map first data and second data to one of the plurality of grids. Further, the terrain data generating device 101 may map the first data and the second data for each tile. The terrain data generating device 101 may set an index for a tile.

In an example, the terrain data generating device 101 may first map the first data for each tile. In this example, through identification information of the first data, the terrain data generating device 101 may determine a tile 602 in which a structure is present. The terrain data generating device 101 may generate terrain data by mapping second data 603 corresponding to an index of the tile 602 to the tile 602.

In another example, if the first data includes (i) a topographic altitude of a predetermined area, (ii) a highest altitude of a structure in the predetermined area, and (iii) a depth of the structure, the terrain data generating device 101 may map the first data for each tile.

In this example, if there is a highest altitude or a depth of a structure, it means that there is a structure in the predetermined area, and thus the terrain data generating device 101 may determine the tile 602 in which the structure is present.

If there are n (n>=2) structures in the predetermined area, the terrain data generating device 101 may generate terrain data by mapping second data 603 with respect n−1 structures corresponding to the index of the tile 602 to the tile 602. In this example, n may be the number of structures in the predetermined area, and may be, if there is a protruding portion of a structure installed in another area is present in the predetermined area, a sum of the number of structures and the number of protruding portions.

According to example embodiments, it is possible to accurately and efficiently analyze terrain by generating terrain data reflecting information associated with a structure such as a building on the actual terrain.

According to example embodiments, it is possible to apply without changing all existing terrain data, thereby solving the issues described above without replacement with new equipment or data.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The units described herein may be implemented using a hardware component, a software component and/or a combination thereof. A processing device may be implemented using one or more general-purpose or special purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A method of generating terrain data, the method comprising:
identifying first data including (i) identification information indicating whether there is a structure in a predetermined area and the number of structures and (ii) a topographic altitude of the predetermined area;
identifying, if there is a structure in the predetermined area, second data including a highest altitude of the structure and a depth of the structure; and
mapping the first data and the second data to terrain data of the predetermined area.

2. The method of claim 1, wherein the mapping comprises mapping the first data and the second data related to the predetermined area to one of a plurality of grids representing the terrain data,
wherein the one grid corresponds to the predetermined area.

3. The method of claim 2, wherein the plurality of grids are grouped into a plurality of tiles of the same size, and
an index is set for a tile in which a structure is present, among the plurality of tiles.

4. A method of generating terrain data, the method comprising,
identifying first data including (i) a topographic altitude of a predetermined area, (ii) a highest altitude of a structure in the predetermined area, and (iii) a depth of the structure;
identifying, if there are a plurality of structures in the predetermined area, second data including respective highest altitudes and depths of the structures; and
mapping the first data and the second data to terrain data of the predetermined area.

5. The method of claim 4, wherein the mapping comprises mapping the first data and the second data related to the predetermined area to one of a plurality of grids representing the terrain data,
wherein the one grid corresponds to the predetermined area.

6. The method of claim 5, wherein the plurality of grids are grouped into a plurality of tiles of the same size, and
an index is set for a tile in which a structure is present, among the plurality of tiles.

7. A device for generating terrain data, the device comprising:
a processor configured to identify first data including (i) identification information indicating whether there is a structure in a predetermined area and the number of structures and (ii) a topographic altitude of the predetermined area, identify, if there is a structure in the predetermined area, second data including a highest altitude of the structure and a depth of the structure, and map the first data and the second data to terrain data of the predetermined area.

8. The device of claim 7, wherein the processor is configured to map the first data and the second data related to the predetermined area to one of a plurality of grids representing the terrain data,
wherein the one grid corresponds to the predetermined area.

9. The device of claim 8, wherein the plurality of grids are grouped into a plurality of tiles of the same size, and
an index is set for a tile in which a structure is present, among the plurality of tiles.
